(19) United States
(12) Patent Application Publication
(10) Pub. No.: US 2003/0098988 A1
(43) Pub. Date: May 29, 2003

(54) Fast printing apparatus and method thereof

(75) Inventors: Kwang-seuk Kim, Suwon-si (KR); Ki-ja Lee, Suwon-si (KR); Hyoung-tae Kim, Gyeonggi-do (KR); Hong-rok Woo, Gyeonggi-do (KR); Yong-jo Park, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/295,045

(22) Filed: Nov. 15, 2002

(30) Foreign Application Priority Data
Nov. 16, 2001 (KR) 2001-71398

(51) Int. Cl. B41B 1/00; G06F 15/00

(52) U.S. Cl. 358/1.13; 358/1.16

(57) ABSTRACT

A fast printing apparatus and method thereof include a host converting job data for a print job into a printing code and analyzing and processing the printing code to produce a display list, and a printer temporarily storing the display list input from the host, producing bit map data by processing the temporarily stored display list, and printing a bit map image corresponding to the produced bit map data. With the use of the fast printing apparatus and method thereof, it is possible to increase a printing speed of the printer.

### CROSS-REFERENCE TO RELATED APPLICATIONS

This application claims the benefit of Korean Patent Application No. 2001-71398, filed Nov. 16, 2001, in the Korean Intellectual Property Office, the disclosure of which are incorporated herein by reference.

### BACKGROUND OF THE INVENTION

1. Field of the Invention

The present invention relates to a printing apparatus and a method thereof, and more particularly, to a fast printing apparatus whose printing speed is improved, and a method thereof.

2. Description of the Related Art

In the past, printing was performed mainly according to a command processing method or a bit map processing method. In the conventional command processing method, a host converts job data for a print job loaded in an application program into a printing code which can be perceived by a printer. Then the host transmits the printing code to the printer. At this time, the printer analyzes and processes the received printing code, generates a display list thereof, and processes the generated display list. Next, the printer generates bit map data and then prints the generated bit map data on a sheet of paper. The conventional command processing method, however, loads down the printer with a large amount of data generated when the printing code is converted into the display list. That is, when the printing code containing information, such as vector graphic and vector fonts, is processed, floating-point calculation for calculating complicated real numbers is required. However, a performance of a central processing unit (CPU) of a regular printer, not a high-performance printer, is much lower than that of a CPU of a commonly used personal computer (PC). For this reason, it takes a lot of time for the regular printer to perform emulation for converting the printing code into the display list if using the conventional command processing method, thereby reducing an efficiency of the print job.

Meanwhile, in the conventional bit map processing method, the host converts the job data into the bit map data and transmits the bit map data to the printer. The conventional bit map processing method performs image rendering for converting the job data into the bit map data using calculations in units of bits, through software. Thus even though a host CPU can fast process data, a lot of time is spent for calculations and the host is burdened with a great load. Therefore, the conventional bit map processing method would lower a performance of the host and the printer when the image rendering is performed through the software. If a user does another job while printing, in the conventional bit map processing method, the performance of the host may deteriorate even more.

In conclusion, the conventional command processing method is disadvantageous, in comparison with the conventional bit map processing method, in that while an amount of data transmitted from the host to the printer can be reduced, the printer is burdened with a lot of load. The conventional bit map processing method is also disadvantageous because it can burden the host with a lot of load.

### SUMMARY OF THE INVENTION

To solve the above and the other problems, it is an object of the present invention to provide a fast printing apparatus which distributes a load to a host and a printer appropriately, thereby increasing a printing speed of the printer.

It is another object of the present invention to provide a fast printing method performed by the fast printing apparatus when the load is distributed to a host and a printer appropriately.

It is another object of the present invention to provide a fast printing apparatus which distributes a load to a host and a printer adaptively to given circumstances, thereby increasing a printing speed of the printer.

It is another object of the present invention to provide a fast printing method performed by a fast printing apparatus when the load is distributed to a host and a printer adaptively to given circumstances.

Additional objects and advantageous of the invention will be set forth in part in the description which follows and, in part, will be obvious from the description, or may be learned by practice of the invention.

To achieve the above and the other objects, there is provided a fast printing apparatus including a host converting job data for a print job into a printing code and analyzing and processing the printing code to produce a display list, and a printer temporarily storing the display list input from the host, producing bit map data by processing the temporarily stored display list, and printing a bit map image corresponding to the produced bit map data.

To achieve the above and the other objects, there is provided a fast printing method performed by a fast printing apparatus having a host and a printer. The fast printing method includes converting job data for a print job into a printing code, and analyzing and processing the printing code to produce a display list, and temporarily storing the produced display list, producing bit map data by processing the temporarily stored display list, and printing a bit map image corresponding to the produced bit map data, wherein the converting of the jab data into the printing code is performed by the host, and the temporarily storing of the produced display list is performed by the printer.

To achieve above and the other objects, there is provided a fast printing apparatus including a host converting print data for a printing job into a printing code, analyzing and processing the converted printing code to produce a first display list, and processing the first display list to produce first bit map data, and a printer producing a second display list by analyzing and processing the printing code input from the host, temporarily storing the produced second display list and the first bit map data input from the host, producing second bit map data by processing the temporarily stored first display list or the produced second display list, and printing a bit map image corresponding to the temporarily stored or produced bit map data.

To achieve the above and the other objects, there is provided a fast printing method performed by a fast printing apparatus having a host and a printer. The fast printing method includes converting job data for a print job into a printing code through the host, determining whether a current mode is a printer mode, a host mode, or a sharing mode, analyzing and processing the printing code to produce a first display list, producing first bit map data by processing the display list, and printing a bit map image corresponding to the first bit map data through the printer when it is determined that the current mode is the printer mode, analyzing and processing the printing code to produce the first display list and processing the first display list to produce the first bit map data through the host, and temporarily storing the first bit map data and printing the bit map image corresponding to the temporarily stored first bit map data through the printer when it is determined that the current mode is the host mode, and analyzing and processing the printing code to produce the first display list through the host, and temporarily storing the first display list, processing the temporarily stored first display list to produce second bit map data, and printing the bit map image corresponding to the produced second bit map data through the printer when it is determined that the current mode is the sharing mode.

### BRIEF DESCRIPTION OF THE DRAWINGS

The above objects and other objects and advantages of the present invention will become more apparent and more readily appreciated from the following description of preferred embodiments, t taken in conjunction with the accompanying drawings of which:

FIG. 1 is a block diagram of a fast printing apparatus according to an embodiment of the present invention;

FIG. 2 is a flow chart explaining a fast printing method performed by the fast printing apparatus of FIG. 1;

FIG. 3 is a block diagram of a fast printing apparatus according to another embodiment of the present invention; and

FIG. 4 is a flow chart explaining a fast printing method performed by the fast printing apparatus of FIG. 3.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

Hereinafter, structures and operations of a fast printing apparatus and a fast printing method according to embodiments of the present invention will be described with reference to the accompanying drawings.

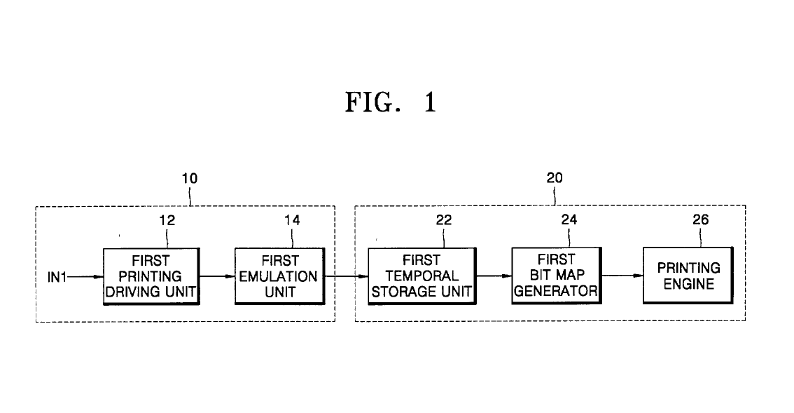

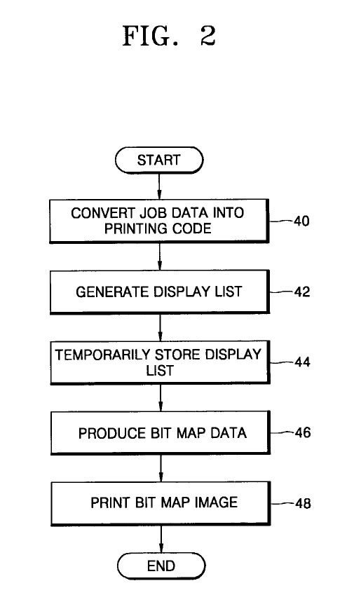

FIG. 1 is a block diagram of a fast printing apparatus according to an embodiment of the present invention. The fast printing apparatus includes a host 10 and a printer 20. FIG. 2 is a flow chart explaining a fast printing method performed by the fast printing apparatus of FIG. 1. The fast printing method includes generating a printing code and a display list by the host 10 operations] in operations 40 and 42 and printing a bit map image using bit map data generated by the printer 20 operations] in operations 44 through 48.

The host 10 of FIG. 1 converts job data (print data) for a print job into the printing code, analyzes and processes the printing code to generate the display list thereof, and outputs the generated display list to the printer 20 in operations] operations 40 and 42. For these operations, the host 10 includes a first printing driving unit 12 and a first emulation unit 14.

The first printing driving unit 12 of the host 10 converts job data input from an input terminal IN1 into the printing code and outputs the printing code to the first emulation unit 14 in operation] operation 40. The job data may be loaded in, for example, an application program and be input to the first printing driving unit 12 during operating the application program. Here, the ‘printing code’ is referred to as a code, which can be analyzed and processed by the printer 20, and means a printer command. Basically, for the print job, there are three types of print data: font, image, and graphic. The printer command is a command for printing elements or objects of the above print data.

After performing operation 40, the first emulation unit 14 analyzes and processes the printing code input from the first printing driving unit 12 and outputs the processing result as a display list to the printer 20 in operation 42. Here, the display list is referred to as data that is converted from each element of the print data, such as the font, the image, and the graphic, to be processed by a first bit map generator 24. The first emulation unit 14 converts the printing code into the display list for image processing when the print data is the image, the font, or the graphic.

According to the present invention, the host 10 can analyze and process, through a program, the printing code that was converted by the first printing driving unit 12 and generate a display list thereof without separately using the first emulation unit 14 analyzing and pre-rendering the printing code.

After performing operation 42, the printer 20 temporarily stores the display list input from the host 10, processes the temporarily stored display list, generates the bit map data, and prints the bit map image corresponding to the generated bit map data in operations 44 through 48. For these operations, the printer 20 includes a first temporal storage unit 22, a first bit map generator 24, and a printing engine 26.

In detail, the first temporal storage unit 22 temporarily stores the display list transmitted from the host 10 and outputs the temporarily stored display list to the first bit map generator 24 in operation 44. After performing operation 44, the first bit map generator 24 processes the temporarily stored display list input from the first temporal storage unit 22 and outputs processing results as bit map data to the printing engine 26 in operation 46. In other words, the first bit map generator 24 converts the temporarily stored display list into a whole image of a combination of respective elements, such as the font, the image, and the graphic, and generates the bit map data corresponding to the whole image.

After performing operation 46, finally, the printing engine 26 prints the bit map image corresponding to the bit map data input from the first bit map generator 24 on the paper in operation 48.

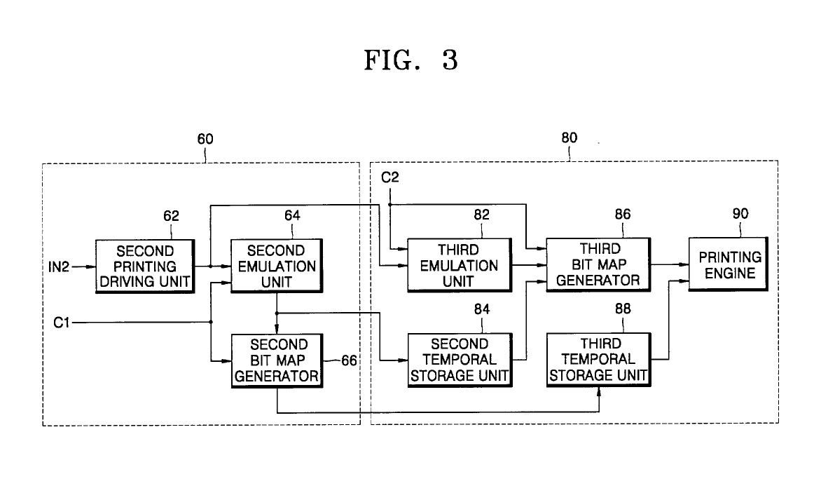

FIG. 3 is a block diagram of a fast printing apparatus including a host 60 and a printer 80 according to another embodiment of the present invention.

The host 60 of FIG. 3 converts job data (print data) for a print job into a printing code, analyzes and processes the printing code to generate a first display list thereof, processes the generated first display list, and generates first bit map data. For these operations, the host 60 includes a second printing driving unit 62, a second emulation unit 64 and a second bit map generator 66.

The second printing driving unit 62 of FIG. 3 converts the job data input from an input terminal IN2 into the printing code and outputs the printing code. At this time, the second emulation unit 64 analyzes and processes the printing code input from the second printing driving unit 62 in response to a first control signal C1 and outputs a processing result as the first display list. Here, the first control signal C1 may be generated in a CPU (not shown) of the host 60 or printer 80 in accordance with a processing capability and a storage capacity of each of the host 60 and the printer 80. At this time, the second bit map generator 66 processes the first display list input from the second emulation unit 64 in response to the first control signal C1, and outputs the processing result as the first bit map data to the printer 80.

According to the present invention, the host 60 can analyze and process through a program the printing code so as to generate the first display list thereof.

Meanwhile, the printer 80 generates a second display list by analyzing and processing the printing code input from the host 60, temporarily stores the second display list and the first bit map data input from the host 60, generates second bit map data by processing the temporarily stored first display list or the generated second display list, and prints a bit map image corresponding to one of the temporarily stored first bit map data or the generated second bit map data. For these operations, the printer 80 includes a third emulation unit 82, a second temporal storage unit 84, a third bit map generator 86, a third temporal storage unit 88 and a printing engine 90.

The third emulation unit 82 of FIG. 3 analyzes and processes the printing code input from the host 60 in response to a second control signal C2 and outputs a processing result as the second display list to the third bit map generator 86. Here, the second control signal C2 may be generated in a CPU (not shown) of the host 60 or printer 80 corresponding to the processing capability and the storage capacity of each of the host 60 and the printer 80. At this time, the second temporal storage unit 84 temporarily stores the first display list input from the second emulation unit 64 of the host 60 and outputs the temporarily stored first display list to the third bit map generator 86. The third temporal storage unit 88 temporarily stores the first bit map data input from the second bit map generator 66 of the host 60 and outputs the temporarily stored first bit map data to the printing engine 90. The third bit map generator 86 processes the first display list input from the second temporal storage unit 84 or the second display list input from the third emulation unit 82, in response to the second control signal C2, and outputs the processing result as the second bit map data to the printing engine 90.

According to the present invention, the first, second, or third bit map generator 24, 66, or 86 illustrated in FIG. 1 or 3 may be realized by a raster graphic processor (RGP) (not shown) that processes the first or second display list through hardware and generates the first or second bit map data. Also, the second bit map generator 66 processes the first display list through software, i.e., through a program, and generates the first bit map data.

The printing engine 90 has the same operations as the printing engine 26 of FIG. 1. In detail, the printing engine 90 finally prints the bit map image corresponding to one of the first and second bit map data input from the third temporal storage unit 88 or from the third bit map generator 86 on a sheet of paper.

According to the present invention, the first temporal storage unit 22 of FIG. 1 or the second temporal storage unit 84 of FIG. 3 can store and output the first display list in units of a page or a band. Here, the band is a portion of a unit page. If the unit page may include 5000 dot image lines, a unit band can include 128 dot image lines. Also, the first, second or third bitmap generator 24, 66 or 86 can process the first or second display list in units of a page or a band and then generates the first or second bit map data.

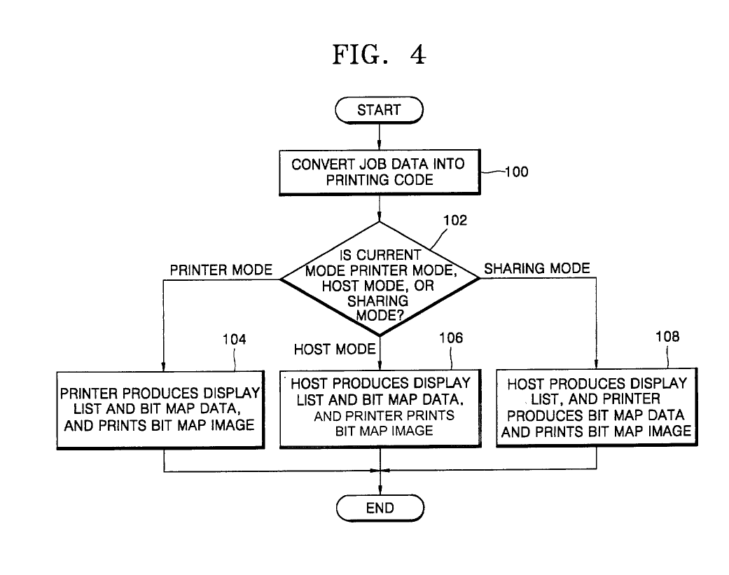

FIG. 4 is a flow chart explaining a fast printing method performed by the fast printing apparatus of FIG. 3. The fast printing method includes converting the job data into the printing code in operation 100 and executing the print job by the host 60, or the printer 80, or both the host 60 and the printer 80 according to a mode of the print job in operations 102 through 108.

First, the second printing driving unit 62 of the host 60 illustrated in FIG. 3 converts the job data for the print job, which is input from the input terminal IN2, into the printing code in operation 100.

After operation 100, the CPU (not shown) of the host 60 or printer 80 selects one of a printer mode, a host mode, and a sharing mode for operating the fast printing apparatus of FIG. 3 in operation 102. Here, the ‘printer mode’ is referred to as a mode for executing the print job using only the printer 80; the ‘host mode’ is a mode of executing the print job only by the host 80; and the ‘sharing mode’ is a mode for executing the print job using both the host 60 and the printer 80.

For operation 102, the CPU of the host 60 or printer 80 compares the processing capabilities and the storage capacities of memories (not shown) of the host 60 and the printer 80 and determines a current mode as the printer mode, the host mode, or the sharing mode, according to a comparison result of the CPU of the host 60 or printer 80.

Hereinafter, conditions determining the current mode will be described. According to an aspect of the present invention, the current mode is determined to be the printer mode when the processing capability of the printer 80 is superior to that of the host 60.

Also, according to another aspect of the present invention, the current mode is determined to be the host mode or the sharing mode in an event that the storage capacity of the printer 80 is large and the processing capability of the host 60 is superior to that of the printer 80. In this case, the current mode may be determined to be the sharing mode so as to reduce a burden on the host 60 when the storage capacity of the host 60 is not large, and the current mode may be determined to be the host mode when the storage capacity of the host 60 is large. Also, although the processing capabilities of the host 60 and the printer 80 are good, the current mode may be either the printer mode or the sharing mode when the storage capacity of the host 60 is insufficient. Here, that the storage capacity is large can be understood as it being larger than that required when the first or second display list is produced from the printing code.

According to still another aspect of the present invention, the current mode is determined as the host mode or the sharing mode when the processing capability of the host 60 is superior to that of the printer 80. In such a case, if the storage capacities of the printer 80 and host 60 are not large, the sharing mode is selected as the current mode. However, if the storage capacity of the host 60 is large and the storage capacity of the printer 80 is not large, the sharing mode is determined as the current mode when the print data is complicated, and the host mode is determined as the current mode when the print data is not complicated.

According to still another aspect of the present invention, if the processing capabilities of the host 60 and printer 80 are good, the current mode is determined as either the printer mode or the sharing mode. In this case, in an event that the storage capacities of the host 60 and printer 80 are not large, the current mode is determined as the sharing mode when the print data is complicated and is determined as the printer mode when the print data is not complicated. However, if the storage capacity of the host 60 is larger than that of the printer 80, the sharing mode is determined as the current mode.

In the aforementioned aspects of the present invention, in an event that the host mode is determined as the current mode because the processing capability of the host 60 is good, the current mode may be determined as either the printer mode or the sharing mode so as to reduce the load of the host 60 when the host 60 is weighted down, e.g., when one host 60 is shared by several printers 80 via networks or the host 60 performs a lot of multi-tasking operations.

Meanwhile, when it is determined that the current mode is the printer mode, the printer 80 analyzes and processes the printing code that is converted by the host 60, produces the second display list thereof, produces the second bit map data by processing the produced second display list, and prints the bit map image corresponding to the produced second bit map data in operation 104. For these operations, the first and second control signals C1 and C2 are generated to control the third emulation unit 82 instead of the second emulation unit 64 to produce the second display list. For instance, the first control signal C1 may control the second emulation unit 64 to not produce the first display list, and the second control signal C2 may control the third emulation unit 82 to produce the second display list.

In other words, in the printer mode, the fast printing apparatus of FIG. 3 operates according to a command processing method. For instance, the host 60 performs operation 40 illustrated in FIG. 2 while the printer 80 performs operations 42, 46 and 48 illustrated in FIG. 2.

However, if it is determined that the current mode is the host mode, the host 60 produces the first display list by analyzing and processing the printing code and produces the first bit map data by processing the first display list, the printer 80 temporarily stores the first bit map data, and prints the bit map image corresponding to the temporarily stored first bit map data in operation 106. For these operations, the first and second control signals C1 and C2 are generated to control the second emulation unit 64 instead of the third emulation unit 82 to produce the first display list, and to control the second bit map generator 66 instead of the third bit map generator 86 to produce the first bit map data. For instance, the first control signal C1 controls the second emulation unit 64 to produce the first display list, and the second control signal C2 controls the third emulation unit 82 not to produce the second display list. Also, the second control signal C2 controls the third bit map generator 86 not to produce the second bit map data, and the first control signal C1 controls the second bit map generator 66 to produce the first bit map data.

That is, the fast printing apparatus of FIG. 3 operates according to a bit map processing method in the host mode. For instance, the host 60 performs operations 40, 42, and 46 of FIG. 2 while the printer 80 performs operation 48.

However, if it is determined that the current mode is the sharing mode, the host 60 produces the first display list by analyzing and processing the printing code, and the printer 80 temporarily stores the produced first display list, produces the second bit map data by processing the temporarily stored first display list, and prints the bit map image corresponding to the produced second bit map data in operation 108. For these operations, the first and second control signals C1 and C2 are generated to control the second emulation unit 64 instead of the third emulation unit 82 to produce the first display list, and to control the third bit map generator 86 instead of the second bit map generator 66 produce the second bit map data. For instance, the first control signal C1 may control the second emulation unit 64 to produce the first display list, and the second control signal C2 may control the third emulation unit 82 not to produce the second display list. Also, for example, the first control signal C1 controls the second bit map generator 66 not to produce the first bit map data, and the second control signal C2 controls the third bit map generator 86 to produce the second bit map data.

That is, in the sharing mode, the fast printing apparatus of FIG. 3 can operate similar to the fast printing apparatus of FIG. 1, using neither by the command processing method nor the bit map processing method. That is, the host 60 performs operations 40 and 42 of FIG. 2, while the printer 80 performs operations 44, 46, and 48 of FIG. 2.

While this invention has been particularly shown and described with reference to a preferred embodiment thereof, it will be understood by those skilled in the art that various changes in form and details may be made therein without departing from the spirit and scope of the invention as defined by the appended claims and their equivalents.

As described above, in a fast printing apparatus and a fast printing method performed by this fast printing apparatus according to the present invention, emulation is performed by a host, not by a printer, unlike a conventional command processing method, thereby improving a performance of the printer. Further, unlike a conventional bit map processing method, a performance of the host can be improved because the printer converts a display list into bit map data. In particular, since the host performs converting a printing code requiring a large storage capacity into the display list, it is possible to prevent in advance a print job failure caused by an insufficient memory of the printer, which is also unlike the conventional command processing method. Also, a print job is performed, in a method selected according to performances and storage capacities of the host and printer, among a command processing method, a bit map processing method, and a sharing method. Therefore, it is possible to improve a printing speed adapted for printing conditions, thereby consequently increasing the printing speed of the printer.

What is claimed is:

1. A fast printing apparatus comprising:
a host converting job data for a print job into a printing code and analyzing and processing the printing code to produce a display list; and
a printer temporarily storing the display list input from the host, producing bit map data by processing the temporarily stored display list, and printing a bit map image corresponding to the produced bit map data.

2. The fast printing apparatus of claim 1, wherein the host comprises:
a first printing driving unit receiving the job data and converting the job data into the printing code; and
a first emulation unit analyzing and processing the printing code and outputting a processing result as the display list to the printer.

3. The fast printing apparatus of claim 1, wherein the host analyzes and processes the printing code using a program to produce the display list.

4. The fast printing apparatus of claim 1, wherein the printer comprises:
a first temporal storage unit temporarily storing the display list input from the host and outputting the stored display list;
a first bit map generator processing the display list input from the first temporal storage unit and outputting a processing result as the bit map data; and
a printing engine printing the bit map image corresponding to the bit map data input from the first bit map generator.

5. The fast printing apparatus of claim 1, wherein the display list is temporarily stored in the printer in page units.

6. The fast printing apparatus of claim 1, wherein the display list is temporarily stored in the printer in band units.

7. The fast printing apparatus of claim 1, wherein the display list is processed in terms of page units when the bit map data is produced.

8. The fast printing apparatus of claim 1, wherein the display list is processed in terms of band units when the bit map data is produced.

9. A fast printing apparatus comprising:
a host converting job data for a printing job into a printing code, analyzing and processing the converted printing code to produce a first display list, and processing the first display list to produce first bit map data; and
a printer producing a second display list by analyzing and processing the printing code input from the host, temporarily storing the first display list and the first bit map data input from the host, producing second bit map data by processing the temporarily stored first display list or the produced second display list, and printing a bit map image corresponding to the temporarily stored first bit map data or the produced second bit map data.

10. The fast printing apparatus of claim 9, wherein the host comprises:
a controller generating a control signal to control one of the host and the printer;
a printing driving unit converting the job data into the printing code and outputting the printing code to the printer;
an emulation unit analyzing and processing the printing code input from the printing driving unit in response to the control signal, and outputting a processing result as the first display list to the printer; and
a bit map generator processing the first display list input from the emulation unit in response to the first control signal, and outputting a processing result as the first bit map data to the printer,
wherein a state of the control signal is determined in accordance with processing performances and storage capacities of the host and the printer.

11. The fast printing apparatus of claim 9, wherein the printer comprises:
a controller generating a control signal to control one of the host and the printer;
a emulation unit analyzing and processing the printing code input from the host in response to the control signal, and outputting a processing result as the produced second display list;
a display list temporal storage unit temporarily storing the first display list input from the host and outputting the stored first display list;
a bit map data temporal storage unit temporarily storing the first bit map data input from the host and outputting the stored first bit map data;
a bit map generator processing the first or second display list input from the display list temporal storage unit or the emulation unit in response to the control signal, and outputting a processing result as the produced second bit map data; and
a printing engine printing the bit map image corresponding to the first or second bit map data input from the bit map data temporal storage unit or the bit map generator,
wherein a state of the control signal is determined in accordance with processing performances and storage capacities of the host and the printer.

12. The fast printing apparatus of claim 9, wherein using a program, the host produces the first display list by analyzing and processing the printing code and produces the first bit map data by processing the first display list.

13. A fast printing method performed by a fast printing apparatus having a host and a printer, the fast printing method comprising:
converting job data for a print job into a printing code and producing a display list from the printing code using the host; and
(b) temporarily storing the produced display list, producing bit map data from the temporarily stored display list, and printing a bit map image corresponding to the produced bit map data using the printer.

14. The fast printing method of claim 13, wherein the converting of the job data into the printing code and the producing of the display list comprise:
analyzing and processing the printing code to produce the display list.

15. The fast printing method of claim 13, wherein the producing of the bit map data and the printing of the bit map image comprise:
processing the temporarily stored display list to produce the bit map data.

16. A fast printing method performed by a fast printing apparatus having a host and a printer, the fast printing method comprising:
converting job data for a print job into a printing code using the host;
determining whether a current mode is a printer mode, a host mode, or a sharing mode;
analyzing and processing the printing code to produce a display list, producing bit map data by processing the display list, and printing a bit map image corresponding to the bit map data using the printer in response to determining that the current mode is the printer mode;
analyzing and processing the printing code to produce the display list and processing the display list to produce the bit map data using the host, and temporarily storing the bit map data and printing the bit map image corresponding to the temporarily stored bit map data using the printer in response to determining that the current mode is the host mode; and
analyzing and processing the printing code to produce the display list using the host, and temporarily storing the display list, processing the temporarily stored display list to produce second bit map data, and printing the bit map image corresponding to the produced second bit map data using the printer in response to determining that the current mode is the sharing mode.

17. The fast printing method of claim 16, wherein the current mode is determined as the printer mode when a processing performance of the printer is greater than that of the host.

18. The fast printing method of claim 17, wherein the current mode is determined as the printer mode when the storage capacity of the printer is more than that required in producing the display list from the printing code.

19. The fast printing method of claim 16, wherein the current mode is determined as the host mode when a processing performance of the host is greater than that of the printer.

20. The fast printing method of claim 16, wherein the current mode is determined as the sharing mode if a processing amount of the host is required to be reduced even though a processing performance of the host is greater than that of the printer.

21. The fast printing method of claim 20, wherein the current mode is determined as either the host mode or the sharing mode when a storage capacity of the printer is smaller than that required in producing the display list from the printing code.

22. A fast printing apparatus comprising:
a controller generating a current mode representing one of a printer mode, a host mode, and a sharing mode;
a host generating a printing code from job data for a print job, selectively generating a first display list from the printing code, and selectively generating first bit map data from the first display list in response to the current mode of the controller; and
a printer selectively generating second bit map data from the first display list in response to the current mode, and printing a print image using one of the first bit map data and the second bit map data.

23. The fast printing apparatus of claim 22, wherein the first bit map data and the second bit map data are the same.

24. The fast printing apparatus of claim 22, wherein the print image printed using the first bit map data is the same as that printed using the second bit map data.

25. The fast printing apparatus of claim 22, wherein the host generates the first bit map data when the printer does not generate the second bit map data.

26. The fast printing apparatus of claim 22, wherein the printer generates the second bit map data when the host does not generate the first bit map data.

27. The fast printing apparatus of claim 22, wherein the printer and the host are not formed in an integrated body.

28. The fast printing apparatus of claim 22, wherein the printer generates a second display list from the printing code of the host in response to the current mode and generates the second bit map data from one of the second display list and the first display list of the host.

29. The fast printing apparatus of claim 22, wherein the display list corresponds to at least one of an image, a font, and a graphic of the print image.

30. The fast printing apparatus of claim 29, wherein the first or second bit map data corresponds to a combination of the image, the font, and the graphic of the print image.

31. The fast printing apparatus of claim 22, wherein the first bit map data forms a first portion of the print image, and the second bit map data forms a second portion of the print image.

32. The fast printing apparatus of claim 22, wherein the controller generates a control signal in response to the current mode to control the host and the printer to generate the first bit map data and the second bit map data, respectively.

33. The fast printing apparatus of claim 22, wherein the host has a first characteristic representing one of a first process capability and a second storage capacity of the host, the printer has a second characteristic representing one of a second process capability and a second storage capacity of the printer, and the controller determines the one of the printer mode, the host mode, and the sharing mode as the current mode in response to the first characteristic of the host and the second characteristic of the printer.

34. The fast printing apparatus of claim 33, wherein the job data has a job data characteristic, and the controller determines the one of the printer mode, the host mode, and the sharing mode as the current mode in accordance with the characteristic of the job data, the first characteristic of the host, and the second characteristic of the printer.

35. The fast printing apparatus of claim 34, wherein the printer does not generate the second bit map data in accordance with the job data characteristic of the job data.

36. The fast printing apparatus of claim 22, wherein the job data has a characteristic, and the controller controls the host and the printer to generate the first bit map data and the second bit map data, respectively, in accordance with the job data characteristic of the job data.

37. The fast printing apparatus of claim 36, wherein the controller determines the one of the printer mode, the host mode, and the sharing mode as the current mode in accordance with the job data characteristic of the job data.

38. The fast printing apparatus of claim 36, wherein the printer does not generate the second bit map data in accordance with the job data characteristic of the job data.

39. The fast printing apparatus of claim 22, wherein the host generates one of the first display list and the first bit map data in response to the current mode.

40. The fast printing apparatus of claim 39, wherein the printer does not generate the second bit map data when the host generates one of the first display list and the first bit map data.

41. The fast printing apparatus of claim 39, wherein the printer prints the print image using the first bit map data when the host generates the first bit map data.

42. The fast printing apparatus of claim 39, wherein the printer generates the second bit map data when the host generates the first display list.

43. A fast printing apparatus comprising:
a host generating a printing code from job data for a print job, a display list in response to the printing code, and bit map data in response to the display list; and
a printer printing a print image using the bit map data.

44. The fast printing apparatus of claim 43, wherein the printer generates second bit map data in response to one of the printing code and the printing list and prints the print image in response to one of the bit map data generated from the host and the second bit map data.
